(19) United States
(12) Patent Application Publication
(10) Pub. No.: US 2015/0305255 A1
(43) Pub. Date: Oct. 29, 2015

(54) WATER DIVERTER FOR PLANT HOLDING DEVICES

(71) Applicant: Aaron Daubenspeck, Wake Forest, NC (US)

(72) Inventor: Aaron Daubenspeck, Wake Forest, NC (US)

(21) Appl. No.: 14/693,408

(22) Filed: Apr. 22, 2015

Related U.S. Application Data
(60) Provisional application No. 61/983,001, filed on Apr. 23, 2014.

(51) Int. Cl. A01G 9/24; A01G 7/00; A01G 9/02; A01G 27/00

(52) U.S. Cl. CPC A01G 9/247; A01G 27/003; A01G 27/008; A01G 7/00; A01G 9/02

(57) ABSTRACT

A device is provided for managing the watering, fertilization and oxygenation of a plant supported in a basket or container. Provided is a thin plastic liner configured to be inserted into a basket for holding and retaining soil and one or more plants. An extension tube is communicatively connected to the liner and extends outwardly therefrom through a lower portion of the basket and which functions to divert water from the liner to an area outwardly of the basket.

This application claims priority under 35 U.S.C. § 119(e) from the following U.S. provisional application: Application Ser. No. 61/983001 filed on Apr. 23, 2014. That application is incorporated in its entirety by reference herein.

### FIELD OF THE INVENTION

The present invention relates to plant baskets and other plant-containing structures and more particularly to a water diverter device that can be incorporated into such plant holding devices for strategically diverting water therefrom.

### BACKGROUND OF THE INVENTION

Plant baskets are beautiful. A wide variety of plants can be contained within them. Of course, plant baskets can be placed in many locations. They are often hung on outdoor porches. From time to time, the hanging plant basket, for example, must be watered. It is not uncommon for water within the hanging basket to seep through the soil or media and flow out the bottom or sides of the basket. This is often a problem. It is a problem because the water from hanging baskets falls onto porch railings, porch floors and on other structures underlying the hanging basket. Besides being unsightly, this water can damage painted surfaces and the underlying structure and this leads to damaged wood and costly repairs.

Therefore, there is a need to control or manage the flow of water from various types of plant baskets.

### SUMMARY OF THE INVENTION

The present invention relates to a device that is incorporated into a plant basket that manages or controls the flow of water from the basket. The device in one embodiment comprises a thin plastic liner that lines the interior of a plant basket and functions to hold or retain water. A water outlet is formed in a lower portion of the liner. Connected to the liner is a tube. Excess water retained by the liner is directed out the outlet and into the tube. The tube can be manipulated and positioned such that water is diverted outwardly away from the basket and away from closely situated structure.

The present invention also entails a device that permits a plant supported in the basket to be flooded and drained. This is a practice that provides for the healthy growth of a plant supported in the basket.

Other objects and advantages of the present invention will become apparent and obvious from a study of the following description and the accompanying drawings which are merely illustrative of such invention.

### BRIEF DESCRIPTION OF THE DRAWINGS

FIG. 1 is a view of a series of components that form a kit that can be employed in accordance with the present invention.

FIG. 2 is a fragmentary sectional view illustrating a water outlet that is integrated with a liner.

FIG. 3 is a view illustrating a plant basket that includes the liner and means for diverting water from the liner incorporated into the plant basket.

FIG. 4 is a cross-sectional view of a plant basket incorporating the liner.

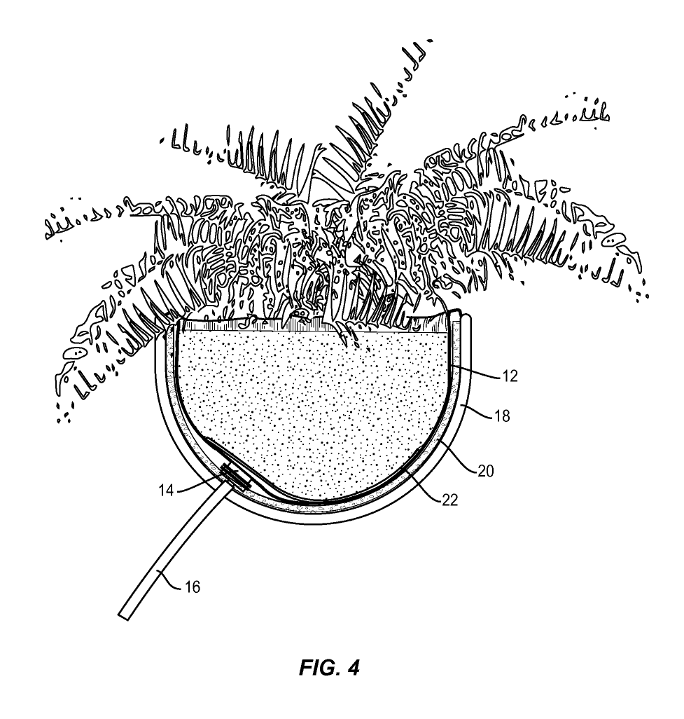

FIG. 4A is another cross-sectional view showing an alternate embodiment for a plant basket incorporating the liner.

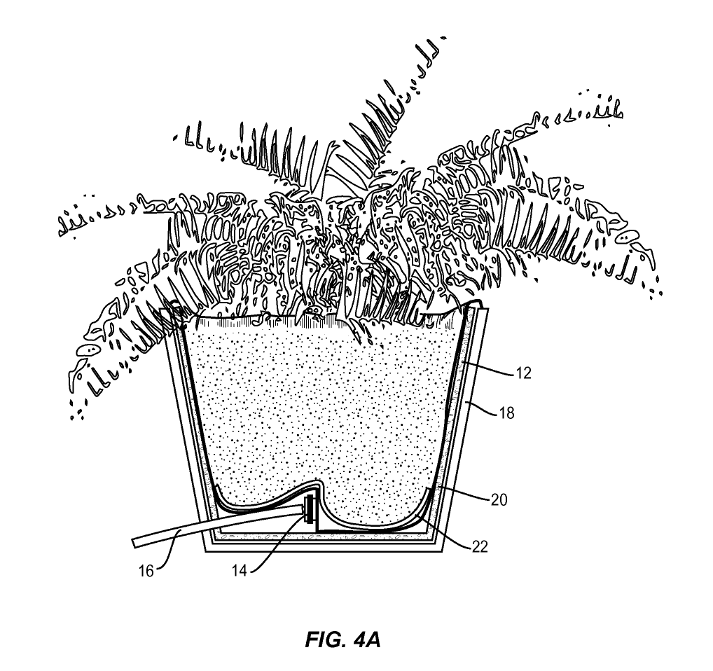

### DESCRIPTION OF EXEMPLARY EMBODIMENT

As discussed above, the present invention relates to a water diverter for plant baskets. In addition to diverting water, the device of the present invention aids in managing the watering, fertilization and oxygenation of a plant supported in a basket. The water diverter is designed to retain water in the basket, channel or direct water from the basket, and direct the water away from the basket and away from underlying structures in the vicinity of the basket.

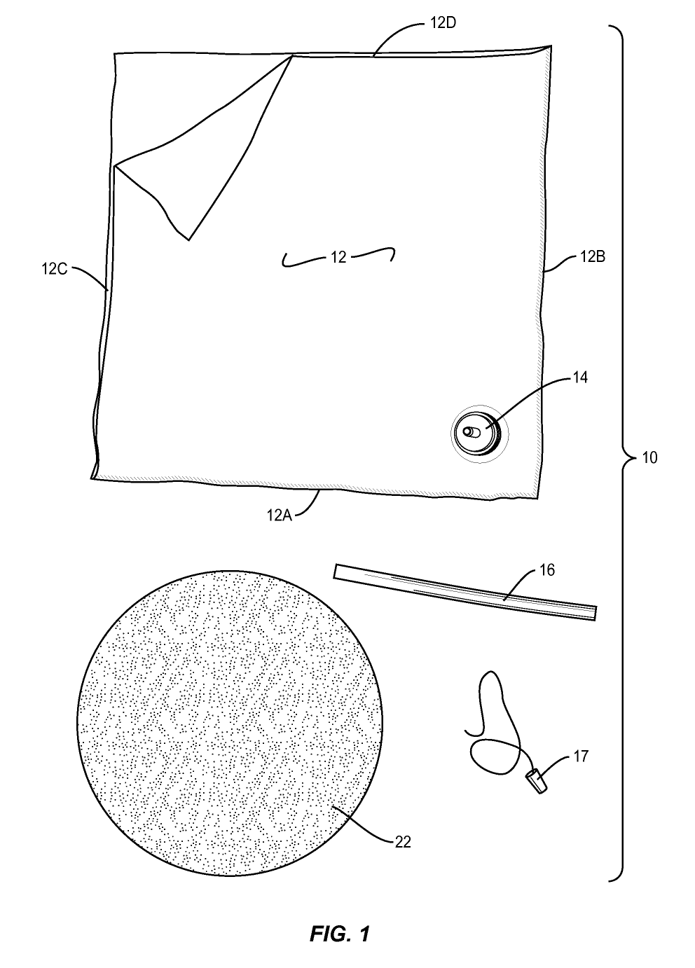

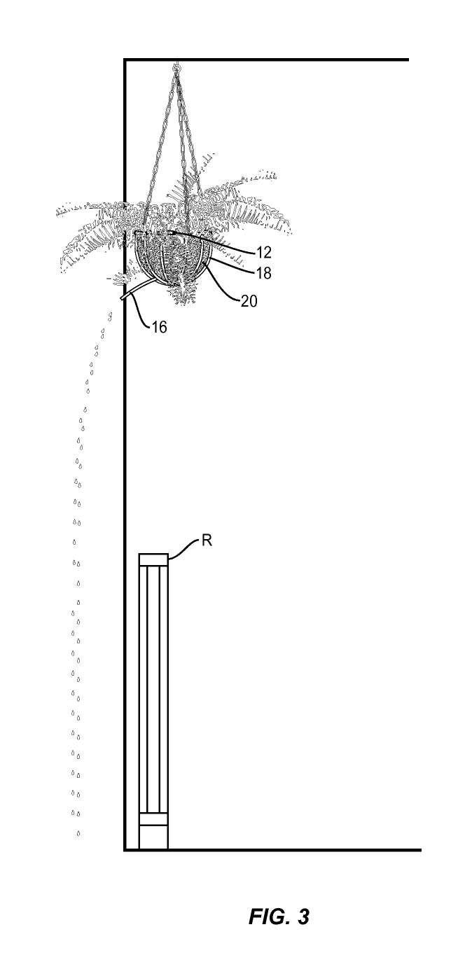

With particular reference to the drawings, the water diverter or water control device is shown in the form of a kit in FIG. 1. Throughout the specification, the device of the present invention may be referred to as a water diverter or a liner for a plant basket. The device is shown in FIG. 1 in the form of a kit and indicated generally by the numeral 10. Device 10 comprises a liner 12. Liner 12 comprises a relatively thin pliable plastic material or sheet that is impervious. Liner 12 is configured to seat in a plant basket 18. See FIG. 3. Once inserted in the plant basket 18, the liner 12 effectively forms a bag or water retaining structure in the basket 18. As noted above, the wall section of the liner 12 is relatively thin. The wall thickness of the liner can vary.

As shown in FIG. 1, the liner 12 is shown forming a part of a kit and the liner is shown in a flattened, unemployed mode. This is referred to throughout as the flattened mode. As depicted in FIG. 1, the liner includes a two-ply construction. That is, the liner 12, as shown in the flattened mode in FIG. 1, includes two relatively thin pliable sheets of plastic material with one sheet overlying the other sheet. Each sheet assumes a generally rectangular or square configuration. Each sheet has equal width and length dimensions in this particular embodiment. It should be pointed out that the shape and size of the liner can vary. As shown in FIG. 1, the liner 12 assumes what is referred to as a closed position. However, the two sheets in this embodiment that form the liner 12 can be separated in order to assume an open configuration. When transformed to the open configuration, the liner 12 is inserted into a basket 18, as illustrated in FIG. 3. When inserted into the basket 18, the liner 12 effectively forms an impervious container that is effective to retain or hold water, and to divert excess water from the liner.

Returning to FIG. 1, it is seen that in the flattened mode the liner 12 includes two seams 12A and 12B. Seams 12A and 12B close two edges of the liner 12. The other two edges (12C and 12D), as viewed in FIG. 1, remain unattached to allow the liner to be opened and to form an open top enclosure when appropriately disposed in the basket 18.

As noted above, one of the functions of the device 10 is to divert water away from a basket containing a plant. In order to achieve this function, the liner 12 is provided with a water outlet 14. In the embodiment illustrated herein, the water outlet 14 is a plastic device integrated into the liner 12 and strategically placed in a corner area bounded by the two seams 12A and 12B. See FIG. 1. By placing the water outlet 14 in this position, it is strategically placed such that when the liner 12 is transformed into an open configuration and inserted into the basket 18, the water outlet is disposed in a lower portion of the basket so as to facilitate the flow of water from the basket.

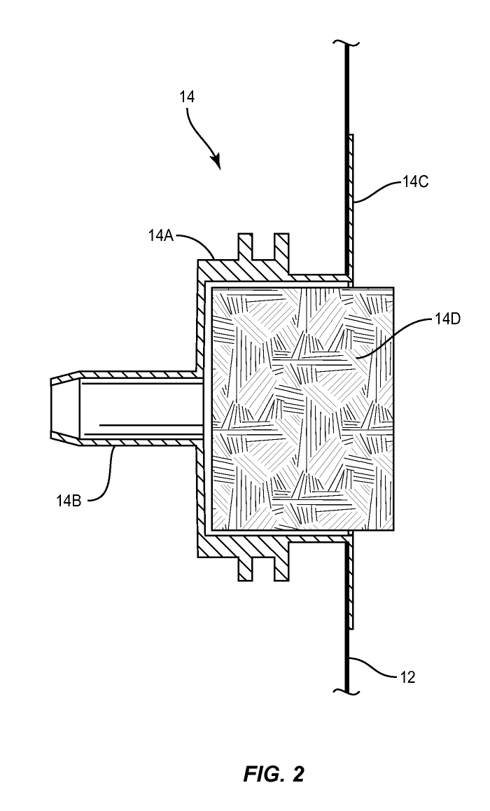

With particular reference to the water outlet 14, it is seen that the same includes a main body 14A and a stub tube 14B extending outwardly from the main body. See FIG. 2. Water outlet 14 should be integrated into the liner 12 such that the connection between the water outlet and the liner is liquid tight. That is, the connection between the water outlet 14 and the liner 12 should be such that water does not leak in this area. There are various ways to incorporate a water outlet into the liner 12. In the embodiment illustrated herein, the water outlet is provided with a connecting flange 14C that extends from the water outlet. Connecting flange 14C is secured around an opening formed in the liner and is attached by heat sealing, gluing or other suitable means to an inside surface of the liner 12 around the opening in the liner. This permits water to flow from inside the liner, through san opening in the liner and into the main body 14A and out the stub tube 14B of the water outlet. Water outlet 14 also includes a cavity or open area for receiving an outlet filter 14D. Outlet filter 14D is secured within the water outlet 14 in the flow path. Thus, water leaving liner 12 and passing through the water outlet 14 passes through and is filtered by the outlet filter 14D.

Connected to the stub tube 14B is a extension tube 16. As seen in FIG. 3, the tube 16 is inserted onto the stub tube 14B and extends outwardly therefrom. Again, the connection between the water outlet 14 and the liner 12, as well as the connection between the water outlet and the tube 16, is such that a sealed, liquid tight connection is formed.

The kit also includes a main filter 20. See FIG. 1. Filter 20 can assume various forms. In the embodiment illustrated, the filter comprises a relatively thin pliable disc that is configured to lie in the bottom of the liner 12 and to cover a substantial area in the bottom portion of the liner.

In one application, the liner 12 is inserted into a plant basket such that the plant and soil or growing medium are contained within the interior of the liner. The liner may be supported or partly supported by an underlying filtering material such as moss or a coco layer 20.

Details of the basket 18 are not dealt with herein because hanging baskets and other plant baskets are well known and appreciated. Suffice it to say that plant baskets come in various sizes and shapes. In the case of the basket 18 shown in the drawings, the basket is of an open frame construction and includes a bottom and an open framed sidewall, as well as an open top. As noted above, it is common practice to seat a filler material, such as a coco layer 20, moss or other known materials, into the outer structure of a basket. Once the liner 12 is inserted into the basket, the filter or other porous structure 20 is placed over the bottom portion of the liner 12. In one example, the relatively thin disc-shaped filter 22 can be provided as a part of the kit. See FIG. 1. Now the medium or soil can be placed into the basket and a plant or plants can be planted therein.

From time to time, the plant in the basket 18 will require water. Thus, water is placed in the basket. Some water will be taken up by the plant or plants therein. Some of the water will be absorbed or retained in the media. But invariably, from time to time, there will be excess water in the basket 18 and this excess water will drain from the basket. However, with the present invention, the liner 12 will retain the water in the basket and prevent the water from draining or seeping from the basket.

Water retained by the liner 12 is directed out the water outlet 14 into the tube 16. In the case of the example shown in FIG. 3, a hanging basket 18 is hung from an overhead structure along the front of a porch. Underlying the hanging basket 18 is a railing R. Note that the tube 16 projects outwardly from the hanging basket 18 and diverts the excess water in the hanging basket outwardly and away from the underlying railing R. This prevents excess water in the hanging basket from dripping down onto the underlying railing. This is an example of the use of the kit shown in FIG. 1 in conjunction with a hanging basket. But it should be appreciated that the device shown in FIG. 1 can also be appropriately used in other baskets that contain one or more plants.

It is appreciated that the tube 16 can be of various lengths and can be manipulated and repositioned with respect to the basket 18. As seen in the drawings, the extension tube 16 is disposed within the lower portion of the basket and is projected outwardly through the surrounding sidewall structure of the basket. In the embodiment illustrated, the device 10 is provided with at least one plug 17 for plugging the end of the tube 16. See FIG. 1. That is, the plug 17 is sized such that it can be frictionally inserted into the outer terminal end of the tube 16 in order to prevent the flow of water through the tube. Thus, if it is desired to retain water in the hanging basket after watering, the plug 17 can be inserted into the end of the tube.

Excess water diverted from the basket can be utilized to water or irrigate other plants. For example, an elongated extension tube can be employed. The extension tube may be a single tube or may include branches that extend therefrom in order to water multiple plants. Such an extension tube can be connected directly to the water outlet 14 or can be connected to the extension tube 16. This provides an efficient means for watering other plants located in the vicinity of the basket having the water diverter incorporated therein. Device 10, discussed above, can be packaged or presented to consumers in various ways. The device 10, as shown in FIG. 1, can be provided in a single package or kit form and the homeowner can easily install the device in existing baskets. In other cases, the device 10 can be incorporated into baskets before the baskets are actually sold to consumers.

The water diverter, shown in the drawings and described herein, has been described in the context of hanging baskets. It is appreciated by those skilled in the art that the present invention is not limited to hanging baskets, but can be incorporated into numerous other plant devices and used to retain water therein and control the flow of water from such plant holding devices.

Device 10 can be used in various ways for various different types of plants. For example, the device 10 is useful in connection with baskets that include ferns. In the case of ferns, for example, after appropriately inserting the liner 12 in a basket, the filter 22 is placed over a bottom area of the liner. Now the plant and soil can be added. Because of the position and orientation of the water outlet 14, all the water in the liner will not be exhausted from the liner. In one example, about three quarters of an inch of water-soaked soil will remain. This allows a small amount of reserve water to be soaked up, allowing more time between watering. In another example, before adding the filter 20, it may be appropriate to add about three quarters to one inch of pea gravel covering the bottom of the liner and then adding the filter 22 above the pea gravel. This creates a separation between the residual or remaining water and the soil and will prevent root rot. This particular application is recommended for automatic drip systems.

There are numerous advantages to employing the device 10 in baskets that contain plants. First, the device diverts planter water away from porches that can cause wood rot, staining, algae and mold. The device creates a barrier from moisture, soil and roots, keeping the fiber liner (for example, the coco layer 20) looking new. By employing the plug 17, this allows one to consistently water, fertilize and oxygenate plant roots using what is often referred to as the “flood and drain” technique. The device also allows one to flood one plant and then drain the water into a watering can that can be used to water another plant. This saves water and nutrients. If the homeowner is planning to be away for a few days, then the plant can be flooded and drained and thereafter the plug 17 and a small amount of water can be added. The device 10 is compatible with automatic drip systems. Furthermore, the device does not detract from the esthetics of the plant. The extension tube 16, in one embodiment, is clear and generally vanishes behind the plant foliage.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A device for use in a plant basket for managing the watering of a plant and diverting water outwardly from the plant basket, the device comprising: a pliable plastic sheet forming a liner and configured to seat in the plant basket and which includes a bottom and a surrounding sidewall and when seated in the plant basket retains water and prevents water from dripping from multiple areas of the plant basket; means for diverting water from the interior of the liner outwardly through the plant basket to an area outwardly of the plant basket; and wherein the means for diverting the water comprises an elongated tube communicatively connected to the interior of the liner and extending therefrom and adapted to extend through a sidewall of the plant basket to a point outwardly and away from the plant basket such that the elongated tube is effective to divert water to a side area with respect to the plant basket.

2. The device of claim 1 including a water outlet integrated into a bottom portion of the liner and communicatively connected to the interior of the liner and communicatively connected to the elongated tube such that water in the liner is constrained to flow through the water outlet and out the elongated tube.

3. The device of claim 2 wherein the water outlet includes a main body and a flange and wherein there is an opening formed in the bottom portion of the liner and the flange is secured around the opening formed in the liner.

4. The device of claim 1 wherein the pliable sheet includes two rectangular or square-shaped plastic panels connected by a series of seams and wherein the panels are sized such that the panels have equal corresponding dimensions.

5. The device of claim 1 further including a filter disposed in the bottom of the liner and wherein the filter is separate from the liner.

6. The device of claim 1 wherein the device forms a part of a plant basket and wherein there is provided a water outlet integrated into the liner and wherein the elongated tube is connected to the water outlet and extends outwardly therefrom through a surrounding wall structure of the plant basket and wherein the elongated tube includes an outer terminal end that is spaced outwardly from the plant basket; and wherein there is provided a plug for plugging the elongated tube and preventing water from flowing out the tube.

7. A device for supporting a plant and managing the watering of the plant, comprising: a plant basket including a bottom, a surrounding sidewall, an open top, and an interior area; a plant supported in the plant basket; soil or a growing medium surrounding a portion of the plant; a plastic liner disposed between the soil or growing medium and the surrounding sidewall of the plant basket; and an elongated tube communicatively connected to the interior area of the liner and extending from the liner through the surrounding sidewall of the plant basket and outwardly past the surrounding sidewall of the plant basket for diverting water from the interior of the liner to a point spaced outwardly from the sidewall of the basket.

8. The device of claim 7 where the liner includes at least two plastic sheets connected by at least one seam and when disposed in the plant basket, the plastic liner forms a bag that holds and diverts water in the interior of the bag outwardly through the tube.

9. The device of claim 7 wherein the liner includes a water outlet formed in a bottom portion of the liner where the water outlet is integrated into the liner and includes an outwardly projecting stub tube that is connected to the elongated tube such that water in the liner is diverted therefrom through the water outlet, stub tube and the elongated tube.

10. The device of claim 9 wherein the water outlet includes a flange heat sealed around an opening formed in the liner.

11. The device of claim 10 wherein the water outlet includes an outlet filter inserted into a water flow path extending through the water outlet.

12. The device of claim 7 including a removable plug that is inserted into a terminal end portion of the elongated tube for blocking the flow of water from the elongated tube.

13. A device for managing the watering and fertilization of a plant and managing the diversion of water from a basket containing the plant, the device comprising: a pliable plastic liner; the liner in a flattened, unemployed mode comprising two panels, one lying over the other, and secured together by a plurality of outer seams that extend around outer edges of the two panels; the two panels being opened along a portion of the outer edge to permit access to an interior area within the liner and to permit the liner to be opened and to form a bag configuration; a water outlet integrated into one of the panels and including a stub tube extending outwardly from the water outlet and wherein the stub tube is communicatively connected to the interior of the liner such that water can be diverted from the interior of the liner and out the stub tube; in an employed mode the panels are open and the liner generally conforms to the shape of the plant basket and includes a sidewall structure that extends around a sidewall of the plant basket and includes an open top that permits a plant and soil to be disposed in the interior of the liner; an extension tube connected to the stub tube and extending outwardly from the liner for diverting water from the liner into an area outwardly of the liner; and a plug configured and shaped for insertion into a terminal end of the extension tube for preventing water from flowing out of the liner.

14. The device of claim 13 wherein the water outlet integrated into the liner includes a main body having the stub tube extending therefrom; and wherein there is a connecting flange extending from the main body and sealed against a side of one of the panels; and wherein there is an opening formed in the panel having the connecting flange secured thereto.

15. The device of claim 14 wherein the main body of the water outlet includes a recessed area formed between the stub tube and the connecting flange; wherein there is an outlet filter disposed within the recessed area for filtering water flowing from the interior of the liner outwardly through the water outlet.

16. The device of claim 13 wherein the liner in a flattened mode includes two rectangular or square-shaped plastic panels, one overlying the other, which defines four edges; and wherein two of the edges are closed with a seam joining the panels together with the other two edges without a seam and open.

17. The device of claim 16 wherein, in the flattened mode, the two overlying panels include four corner areas and wherein the water outlet is secured in one panel in one corner area bounded by two separate seams extending along two separate edges.

18. The device of claim 13 wherein, in the employed mode, the device includes a main filter disposed in the bottom of the liner and overlying the water outlet.

19. The device of claim 13 wherein the device forms a part of a plant basket wherein the plant basket includes a bottom and a sidewall, and wherein, in an employed mode, the panels of the liner are open and spaced apart such that the panels form an open top bag seated and supported in the plant basket with the panels lying adjacent a sidewall of the plant basket and wherein the liner includes an open top disposed adjacent a top portion of the plant basket.

20. The device of claim 19 wherein the extension tube projects from the liner through the sidewall of the plant basket and is inclined generally downwardly and outwardly relative to the plant basket such that the extension tube is effective to divert water from the interior of the liner to a point substantially outwardly of the plant basket.
